(19) United States
(12) Patent Application Publication
(10) Pub. No.: US 2005/0127144 A1
(43) Pub. Date: Jun. 16, 2005

(54) Method of mounting a semiconductor laser component on a submount

(76) Inventors: Atuhito Mochida, Shizuoka-shi (JP); Korekazu Mochida, Shizuoka-shi (JP); Kyoko Mochida, Shizuoka-shi (JP); Hiroto Inoue, Hirakata-shi (JP); Suguru Nakao, Itami-shi (JP); Yukihiro Iwata, Ibaragi-shi (JP); Akira Takamori, Suita-shi (JP); Hideto Adachi, Oakayama-shi (JP); Masatoshi Tamura, Takatsuki-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/730,982

(22) Filed: Dec. 10, 2003

(51) Int. Cl. B23K 31/02

(52) U.S. Cl. 228/234.1; 228/228

(57) ABSTRACT

The present invention to provide a method of mounting a semiconductor laser component capable of preventing deterioration of laser characteristics and destruction of the semiconductor laser component due to residual stresses as well as preventing decrease of a lifetime due to increase in temperature of the semiconductor laser component. The method of mounting a semiconductor laser device which comprises a step of pressure bonding a semiconductor laser component on a submount by a collet while a bonding member is heated to be fused or melt on a submount by heating a table on which the submount is placed, for example, characterized in that the table and the collet are heated to a temperature higher than a fusing point of said bonding member so as not to occur the heat transfer substantially to a collet, and then heating of the table and the collet is terminated with maintaining the pressure bonding state.

### BACKGROUND OF THE INVENTION

1. Field of the Invention

The present invention relates to a method of mounting the semiconductor laser component on a submount.

2. Description of the Related Art

When a semiconductor laser component is used in systems such as an optical communication system, an optical disk, a laser, a laser-beam printer and the like, such element is packaged suitably for its use. In packaging the semiconductor laser component, a direct bonding method of directly bonding the semiconductor laser component to a component, which is disposed in the package, such as a metal block, a circular stem, and the like can be used. However, since a structure obtained through this method is simple while the heat releasing property of the semiconductor laser component is not good, temperature thereof increases and stress on the bonding phase generates by the difference of thermal expansion rate and then thus a lifetime of the semiconductor laser component is shortened. For this reason, it is difficult to use the direct bonding method in a high-power semiconductor laser component.

Therefore, in order to solve the above problem, there has been a method for mounting a semiconductor laser component on a submount made of SiC which is excellent in thermal conductivity and processability and has a thermal expansion rate close to that of semiconductor laser component and also bonding the resultant semiconductor laser device to a package. Recently, a bonding method with a submount having an excellent heat releasing property is widely used.

Now, a conventional method of mounting a semiconductor laser component will be described. FIG. 6 is a view illustrating processes of mounting a semiconductor laser component, wherein reference numeral 1 indicates a semiconductor laser component, 2 indicates a submount, 3 indicates a bonding member made of eutectic solder, 4 indicates a collet, and 5 indicates a heating table.

First, as shown in FIG. 6A, the submount 2 is set on the heating table 5 and then the submount is heated up to a temperature of 130° C. or more at which the bonding member 3 on the submount 2 is melted. In the meantime, the semiconductor laser component 1 is held through vacuum absorption by the collet 4, and is positioned on the mount surface of the submount 2.

Next, as shown in FIG. 6B, after the bonding member 3 is melted, the collet 4 holding the semiconductor laser component 1 descends to mount the semiconductor laser component 1 on the bonding member 3 of the submount 2 and make it cooled. At that time, in order to secure an enough bonding area between the semiconductor laser component 1 and the submount 2 sandwiching the bonding member 3 and to improve the heat conductivity by making the bonding member 3 thin, the semiconductor laser component is pressure bonded on the submount by the collet 4. Next, as shown in FIG. 6C, after the bonding member 3 is completely coagulated, the collet 4 releases the semiconductor laser component 1 and ascends.

The bonding method using the submount enables for the semiconductor laser component to be high-powered. However, the higher-powered semiconductor laser component results in enlargement of the submount, and widening of the bonding area between the semiconductor laser component 1 and the submount 2 sandwiching the bonding member 3.

In this regard, the enlargement of the submount 2 and the widening of the bonding area accompanied with the higher-powered semiconductor laser component have caused the following problems. A volume of a substance is varied according to variation of temperature, and the rate of change (thermal expansion coefficient) of every substance is different. For this reason, when different substances are heated to bond to each other, a difference in temperature exists for a time period from the complete coagulation of the bonding member to the recovery to a normal temperature. Thus, a shearing force due to difference in thermal expansion coefficient is generated in the bonded portion and this shearing force causes a residual stress in the substances. Further, the residual stresses are varied depending upon sizes and shapes of the substances and the residual stresses generated in the semiconductor laser component 1 increase with the enlargement of the submount 2 because of the following reasons.

FIGS. 7A to 7D are conceptual views illustrating variation in the residual stresses depending upon variation in size of the submount 2, in which of FIGS. 7A and 7B are an overview and a conceptual view illustrating generation of stresses when the submount 2 is small and of FIGS. 7C and D are an overview and a conceptual view illustrating generation of stresses when the submount 2 is large. When the thermal expansion coefficient of the semiconductor laser component 1 is large, a force acts on the semiconductor laser component 1 in a direction of decreasing the bonding area and a force acts on the submount 2 in a direction of maintaining the bonding area. When the submount 2 is small as in FIG. 7B, the force of maintaining the bonding area is a shearing force generated when the submount 2 below a bonding surface is compressed. When the submount 2 of FIG. 7D is larger than the submount 2 of FIG. 7B, the force of maintaining the bonding area is the shearing force generated when the submount 2 below the bonding surface is compressed and a shearing force generated when the remaining submount 2 at the periphery of the submount 2 in which the shearing force is generated is tensioned.

When the semiconductor laser components 1 have the same size as the submount 2 in the two cases, the shearing forces generated when the submount 2 is compressed are equal to each other. Therefore, the large submount 2 has the stronger force of maintaining the bonding area by the shearing force generated due to the tension, and this shearing force is stronger with increase in size of the submount 2. For this reason, the larger the submount 2 becomes, the stronger the shearing force acting on the semiconductor laser component 1 becomes. Therefore, the residual stress generated in the semiconductor laser component 1 increases with increase in size of the submount 2. Furthermore, the same is true of the semiconductor laser component 1 having a smaller thermal expansion coefficient.

Furthermore, if the bonding area between the semiconductor laser component 1 and the submount 2 sandwiching the bonding member 3 is made large in order to enhance the heat conductivity, the residual stress of the semiconductor laser component 1 increases for the following reasons. When the semiconductor laser component bonded to other substance is cooled, compression occurs around a center of the bonding surface. For this reason, the farther a place is from the center, the greater the difference in the amount of compression between different substances becomes and thus the shearing force becomes lager. If the bonding area increases, places away from the center are bonded, and thus the shearing force becomes larger than the area ratio. For this reason, the residual stress due to this shearing force increases.

As described above, in order to secure an enough bonding area between the semiconductor laser component 1 and the submount 2 sandwiching the bonding member 3 and to improve the heat conductivity by making the bonding member 3 thin, the semiconductor laser component is pressure bonded on the submount by the collet 4. However, since the semiconductor laser component 1 and the submount 2 are bonded with the stress generated due to the pressure bonding, the stress due to the pressure bonding remains in the semiconductor laser component 1 even after the release of the pressure bonding by the collet 4. At that time, if the bonding area enlarges, the fluid resistance of the bonding member 3 increases and thus the force required for the pressure bonding increases. For this reason, the residual stress remaining in the semiconductor laser component 1 due to the pressure bonding increases with the enlargement of the bonding area.

Moreover, since semiconductor laser devices are made up by means of heating joint, the submount 2 and the joint plane of the semiconductor laser component 1 become high temperature, but since the collet 4 is not usually heated, the collet 4 and the contact surface of the semiconductor laser component 1 with the collet 4 are still low temperature. In the semiconductor laser component 1, the difference of temperature more than 100° C. occurs at the time of mounting and the high temperature section expands by thermal expansion. Consequently, the semiconductor laser component 1, as shown in FIG. 8A, becomes curved. Then, if a semiconductor laser device is cooled in a cooling process, the semi conductor laser component 1 will finally be cooled to an uniform temperature and will be returned to the original flat form as shown in FIG. 8B. However, since the bonding member 3 is solidified in the curved form as shown in FIG. 8A, the semiconductor laser component 1 will be prevented from returned to the original form by cooling, and residual stresses occur near the junction part.

In order to improve the heat releasing property, the submount 2 is bonded to the vicinity of a light emitting region of the semiconductor laser component 1. For this reason, the light emitting region is positioned at a zone having high residual stresses in the semiconductor laser component 1. Furthermore, for the semiconductor laser devices in recent years, not only a higher output of the semiconductor laser component 1 but also miniaturization and integration of a device are required. Therefore, in case of the conventional semiconductor laser device, the submount 2 is required to be used not only as the shock absorbing material and the heat dissipation member of the semiconductor laser component 1 but also as the other function materials. Therefore, it becomes impossible to choose the quality of the material of submount 2 freely, and consequently impossible to fully achieve the original function of submount 2.

In general, when current flows in the semiconductor laser component 1 under a stress of 100 MPa or more applied to the light emitting region, crystals are transposed, resulting in deterioration of the laser characteristic and destruction of the semiconductor laser component 1. This phenomenon occurs when the stress of 100 MPa or more is applied to a part of the light emitting region. In addition, the higher-powered semiconductor laser component 1 makes the residual stress in the light emitting region larger, so that the deterioration of laser characteristic and the destruction of the semiconductor laser component 1 many times happen.

As described above, since the residual stress of the semiconductor laser component 1 is generated locally due to various causes and the distribution of residual stress is variable due to sizes and shapes of the semiconductor laser component 1, the submount 2 and the collet 4, and the pressing force of the collet 4, etc. Accordingly, there is no correlation between the macroscopic deformation (bending) and the residual stress of the semiconductor laser component 1, which makes it difficult to specify the cause.

### SUMMARY OF THE INVENTION

In order to solve the above problems, it is an object of the present invention to provide a method of mounting a semiconductor laser component capable of preventing deterioration of laser characteristics and destruction of the semiconductor laser component due to residual stresses as well as preventing decrease of a lifetime due to increase in temperature of the semiconductor laser component.

According to a first aspect of the present invention, there is proposed a method of mounting a semiconductor laser device which comprises a step of pressure bonding a semiconductor laser component on a submount by a collet while a bonding member is heated to be fused or melt on a submount by heating a table on which the submount is placed, for example, characterized in that the table and the collet are heated to a temperature higher than a fusing point of said bonding member so as not to occur the heat transfer substantially to a collet, and then heating of the table and the collet is terminated with maintaining the pressure bonding state, and said semiconductor laser component is released from the collet after all of the bonding members solidify.

Heating of table and collet to the temperature higher than a fusing point of said bonding member is carried out so as not to occur the heat transfer substantially to the collet. Therefore, it is good to heat said collet to the same temperature as said heating table at the time of heating the table and the collet, and to give the same temperature profile as said heating table to said collet at the time of cooling of said semiconductor laser component, when controlling bending of a semiconductor laser component. The method of giving a temperature profile is not limited and can be carried out by controlling energization of an exothermic coil, for example.

Moreover, if a part near a contact surface of the semiconductor laser component is set to a lower temperature while a part near a contact surface of the collet is set to a higher temperature, a temperature difference there between causes the semiconductor laser component bent like a convex. On the other hand, a thermal expansion coefficient difference between the semiconductor laser component and the submount and a bonding pressure of the collet makes concave bendings of both semiconductor laser components. Therefore, both bendings are negated mutually, so that the residual stress in the semiconductor laser component 1 will be preferably decreased.

Then, when the table and the collet are heated, it is desirable to heat said collet to a temperature higher than said heating table and to maintain the collet at a higher temperature than the heating table at the time of cooling of the semiconductor laser component until said bonding member solidifies completely.

When the semiconductor laser component is held by collet, it may be kept at a room temperature. Heating of the semiconductor laser component can avoid a rapid temperature change of the semiconductor laser component, resulting in no degradation of laser characteristics or no breakage of a semiconductor laser component and shortening of the mounting time. Therefore, before holding said semiconductor laser component by said collet, it is preferable to heat said semiconductor laser component to the same temperature substantially as that of the collet. According to the method of mounting a semiconductor laser device of this invention, said semiconductor laser component can be released from said coliet when a part of said bonding member solidifies.

In case of using the above method of partially solidification of the bonding member, it is preferable to use a bonding member comprising a plural of materials having a different fusing point where a material having a higher fusing point will solidify first. At the time of partially solidifying, the semiconductor laser will be released from the collet.

Moreover, it is recommendable to make a part of the bonding member solidify by forced air during pressure bonding of a semiconductor laser component by collet.

According to the method of mounting a semiconductor laser device of this invention, it is preferable that when holding said semiconductor laser component by the collet, said collet has a pair of sides, which contacting side has an area larger than that of a contacting portion contacted with said semiconductor laser component so as to cover the contacting portion of the semiconductor by the contacting portion of the collet.

In the present invention, it is preferable to use a collet having a contacting side face, a part of which contacts a semiconductor laser component and is made of a material with low heat conductivity. The remaining part of the contacting side face is not limited and preferably made of a material having a lower heat conductivity

In the present invention, it is preferable that the semiconductor component is bonded near the macro-axis side thereof on said submount by said bonding members and the remaining parts contact on said submount through a heat transmission member having a low bonding power. The heat transmission member may be a material having a bonding power lower than that of the bonding member. The bonding member is preferably made of a material with a fusing point lower than an eutectic solder. As long as the quality of the material of bonding member is the quality of the material with a fusing point lower than an eutectic solder, it may not be limited, but it may be what kind of the quality of the material.

This invention has an effect which is indicated below.

According to the present invention, a semiconductor laser component is pressure bonded to the submount by the collet, preventing the heat transfer to a collet and a semiconductor laser component is released from a collet, after heating of a heating table and a collet is terminated, with the pressure bond by the collet and the bonding member solidifys completely. Therefore, the residual stress by the difference of temperature in a semiconductor laser component can be decreased, so that degradation of laser characteristics or breakage of a semiconductor laser component can be controlled.

Moreover, according to the present invention, the residual stress by the difference of temperature in a semiconductor laser component can not generate because the collet is heated to the same temperature as that of the heating table, so that the heat transfer to the collet being prevented and then the same temperature profile as a heating table is given to the collet at the time of cooling of a semiconductor laser component, so that degradation of laser characteristics or breakage of a semiconductor laser component can be prevented.

Further, according to the present invention, since the residual stress due to the thermal expansion coefficient difference between the semiconductor laser component and the submount and the residual stress duet to the temperature difference in the semiconductor laser component are negated each other by maintaining the collet to a temperature higher than the heating table until the bonding member solidifies completely at the time of cooling of a semiconductor laser component, degradation of laser characteristics or breakage of a semiconductor laser component can be prevented.

Moreover, according to the present invention, before vacuum adsorption of the semiconductor laser component, heating of the semiconductor laser component to the same temperature as the collet, can prevent the heat transfer to the collet, thereby degradation of the laser characteristics by rapid temperature change or breakage of a semiconductor laser component can be controlled, and the mounting time can be shortened.

Further, according to the present invention, the submount is installed on the heating table and the heating table is heated to a temperature higher than the fusing point of the bonding member, and the semiconductor laser component vacuum absorbed by the collet is moved to a loading position of the submount, and the semiconductor laser component is pressure bonded to the submount by the collet, and when heating of the heating table is terminated, with the pressure bonding by the collet, and the semiconductor laser device is cooled and a part of the bonding member solidifies, the semiconductor laser component is released from the collet. Thereby, the residual stress by the difference of temperature in the semiconductor laser component and the residual stress by pressure bond of the collet can be decreased, and degradation of laser characteristics or breakage of a semiconductor laser component can be controlled.

Moreover, according to the present invention, the semiconductor laser component can be released from the collet after a part of the bonding member has solidified because of the bonding member comprising two or more kinds of the materials having a different fusing point. Thereby, the residual stress can be decreased and degradation of laser characteristics or breakage of a semiconductor laser component can be controlled.

Further, according to the prtesent invention, since a semiconductor laser component can be made to be released from the collet after a part of the bonding member has solidified by forced air cooling at the time of the pressure bonding by the collet, the residual stress can be decreased and degradation of laser characteristics or breakage of a semiconductor laser component can be controlled.

Moreover, since the residual stress by pressure bond of a collet can be decreased by the intension of the contact surface of a semiconductor laser component being made to be carried out to the field portion which a collet contacts when the field portion in contact with the semiconductor laser component of a collet is made larger than the field portion in which a semiconductor laser component is contacted and a semiconductor laser component is held by the collet, degradation of laser characteristics or breakage of a semiconductor laser component can be controlled.

According to the present invention, since the area of the collet contacting with the semiconductor laser component is made larger than the contacting area of the laser component and the contacting area of the semiconductor laser component is enclosed by the contacting area of the collet when the semiconductor laser component is held by the collet, the residual stress due to the pressure bonding of the collet can be decreased and degradation of laser characteristics or breakage of a semiconductor laser component can be controlled

Further, according to the present invention, since the collet has a contacting area made of the low heat conductivity quality of the material which prevents the heat transfer to the collet so as to decrease the residual stress due to a temperature difference in the semiconductor laser component, degradation of laser characteristics or breakage of a semiconductor laser component can be controlled

Moreover, since the residual stress of a luminescence range can be reduced without spoiling the heat dissipation capability of a semiconductor laser component by using the bonding member only near the macro-axis side of the planes of the semiconductor laser component, and making the heat transmission member positioned between the submount and the semiconductor laser component, degradation of laser characteristics or breakage of a semiconductor laser component can be controlled.

Moreover, since the residual stress by the thermal expansion coefficient difference of the residual stress and the residual stress due to the difference of temperature in the semiconductor laser component and submount can be reduced by using the bonding member of the quality of the material with a fusing point lower than an eutectic solder, degradation of laser characteristics or breakage of a semiconductor laser component can be controlled.

### BRIEF DESCRIPTION OF THE DRAWINGS

The above and other objective and features of the present invention will become more apparent from the following description of the preferred embodiments thereof with reference to the accompanying drawings throughout which like parts are designated like reference numerals, and wherein:

FIG. 1 is a side view illustrating processes of mounting a semiconductor laser component according to the first embodiment of this invention,

FIGS. 2A and 2B are side views illustrating processes of mounting a semiconductor laser component according to the second embodiment of this invention,

FIGS. 3A to 3B are side views illustrating processes of mounting a semiconductor laser component according to the third embodiment of this invention,

FIG. 4 is a side view illustrating processes of mounting a semiconductor laser component according to the forth embodiment of this invention,

FIG. 5 is a perspective view illustrating processes of mounting a semiconductor laser component according to the fifth embodiment of this invention.

FIGS. 6A to 6C are side views illustrating processes of mounting a semiconductor laser component according to the present invention,

FIGS. 7A to 7D are conceptual views illustrating difference in residual stress depending upon different sizes in measurement of a submount.

FIGS. 8A and 8B are conceptual views illustrating generation of residual stresses by a collet.

### DESCRIPTION OF THE PREFERRED EMBODIMENTS

Now, the following embodiments of the present invention will be described with reference to the above Figures. In addition, the following concrete form and concrete structure of each part is one of examples when the present invention will be applied to the embodiment. Therefore, the technical range of this invention is not limited by the examples and is not interpreted by these limitations.

### Embodiment 1: Preventing the Heat Transfer to a Collet

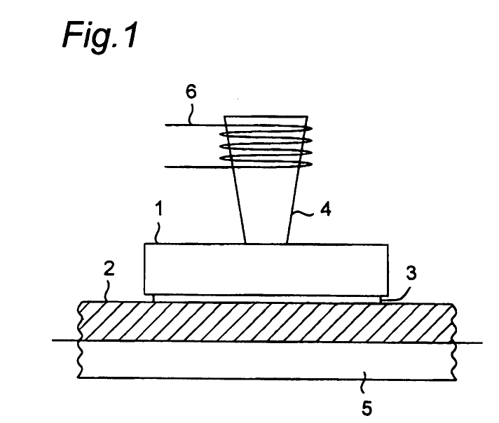

FIG. 1 is a side view illustrating processes of mounting a semiconductor laser component. The semiconductor laser device comprises a based semiconductor laser component 1 having a light emitting portion, a submount 2 for mounting the semiconductor laser component 1, and a bonding member 3 for bonding the semiconductor laser component 1 on the mount surface of the submount 2.

In the mounting method of the first embodiment of this invention, as shown in FIG. 1A, the submount 2 is set on a heating table 5, and the submount 2 is overheated up to a temperature more than a melting point of the bonding member 3 on the submount 2.

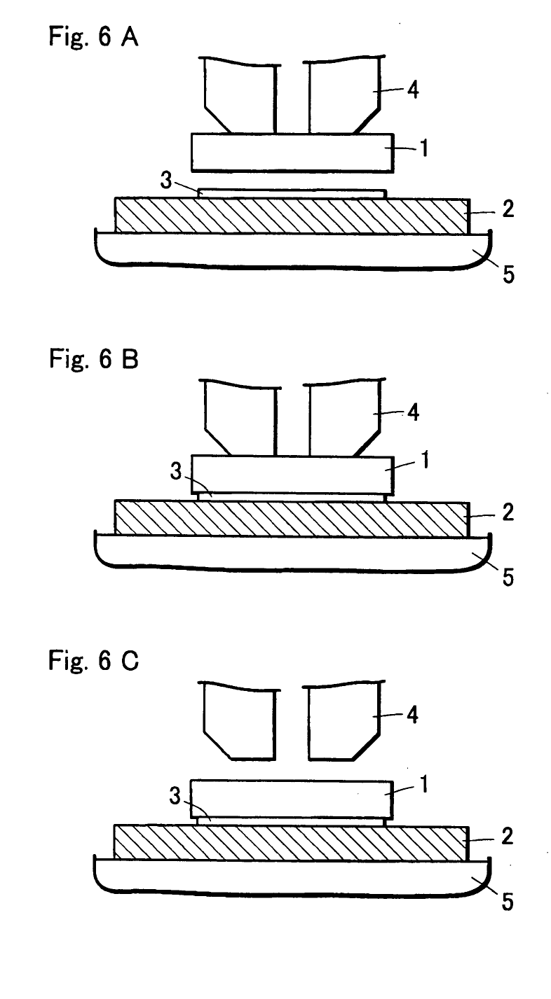

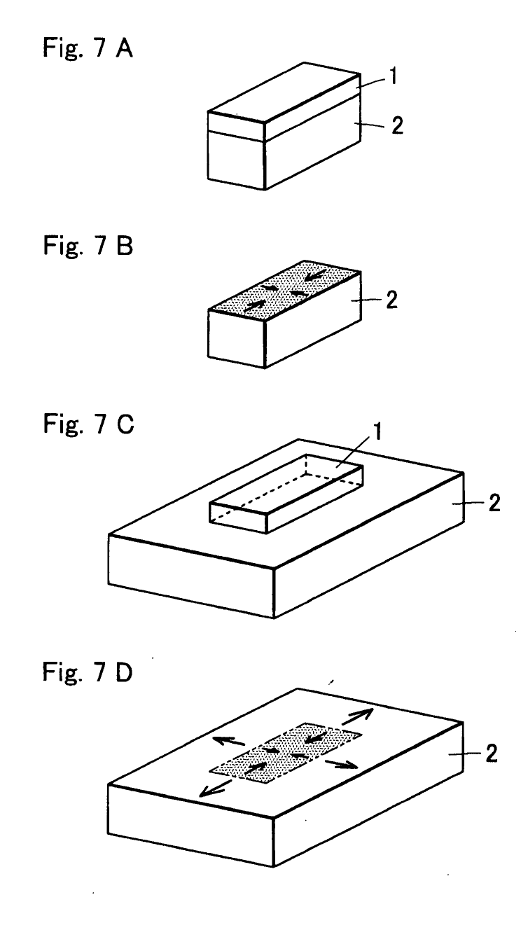

On the other hand, before holding the semiconductor laser component 1 by the collet 4, after heating the collet 4 with the exothermic coil 6, by using vacuum adsorption of the collet 4, the semiconductor laser component 1 is held and moved up to a loading position of the submount 2 (refer to FIG. 6A).

If the bonding member 3 fuses, the collet 4 holding the semiconductor laser component 1 will be dropped, the semiconductor laser component 1 will be carried on the bonding member 3 of the submount 2, and it will be cooled as it is.

At the time of heating and cooling the collet 4, the collet 4 should be heated to a temperature higher than a fusing point of the bonding member 3, and heating of a heating table 5 should be terminated at the same time of ending of the collet 4 heating, thereby the same temperature profile as the heating table being given to the collet 4. The collet may be heated to a temperature higher than the heating table 5, and the collet 4 may be maintained at a temperature higher than the heating table 5 also at the time of cooling.

Moreover, in order to fully secure a bonding area between the semiconductor laser component 1 and the submount 2 through the bonding member 3, and to make thickness of the bonding member 3 thin as much as possible and to improve a heat-conducting characteristic, the semiconductor laser component is preferably pressure bonded by the collet 4 (refer FIG. 6B). When the bonding member 3 solidifies completely, the semiconductor laser component 1 will be released from vacuum adsorption of the collet 4, and will be raised by the collet, a semiconductor laser device will be obtained (refer to FIG. 6C).

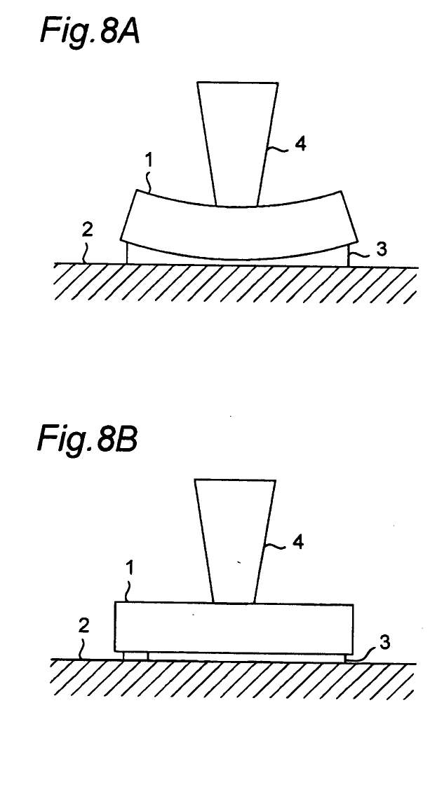

Next, referring to FIGS. 1 and 8 an effect of this mounting method in this embodiment 1 will be explained.

In a conventional mounting method, a heating joint is carried out without the collet 4 being not heated, thereby the semiconductor laser component 1 having a temperature difference of more than 100° C. Consequently, the semiconductor laser component 1 curves in a concave, as shown in FIG. 8A. Then, if a semiconductor laser device is cooled in a cooling process, the semiconductor laser component 1 tends to return to a flat form which does not have bending as shown in FIG. 8B. However, since the bonding member 3 is solidified in the state where it curved in a concave as shown in FIG. 8A, the semiconductor is prevented from returning to the original form by cooling, thereby residual stresses occur near junction parts.

Moreover, another residual stresses generate generated near the junction part, resulting from a difference of temperature and thermal expansion coefficient after the bonding member 3 solidifies completely until it returns to an ordinary temperature.

Generally, since the thermal expansion coefficient of the semiconductor laser component is larger than that of the submount 2, the semiconductor laser component 1 tends to return to an original form while the semiconductor laser component is prevented from returning thereto, thereby making residual stresses near the junction parts.

Furthermore, in order to improve a heat-conducting characteristic from the semiconductor laser component 1 to the submount 2, pressure bonding of the semiconductor laser component 1 by the collet 4, makes a bonding area of the bonding member 3 fully secured, and also makes a thickness of the bonding member thin as much as possible.

Since the collet 4 pressure bonds the semiconductor laser component 1 at a center thereof, the semiconductor laser component 1 tends to curve in a concave.

Therefore, the semiconductor laser component 1 and the submount 2 are joined after a stress has occurred by pressure bond, and also after releasing pressure bond of the collet 4, stresses by pressure bonding remain in the semiconductor laser component 1.

Since all bendings that happen to the semiconductor laser component 1 by the three above-mentioned factors are the same directions, if these factors lap, the residual stresses will be doubled without negating each other.

These residual stresses increase due to enlargement of the submount 2 and increase of the bonding area accompanied with the high-power semiconductor laser component. In order to improve the heat releasing property, the submount 2 is bonded to the vicinity of a light emitting region of the semiconductor laser component 1, and as a result, the residual stress generated in the semiconductor laser component 1 is concentrated in the vicinity of the bonding surface with the submount 2. Therefore, the residual stress becomes higher in the light emitting region.

In general, when current flows in the semiconductor laser component 1 by applying a stress of 100 MPa or more to the light emitting region, crystals are transposed, which deteriorate the laser characteristic or destroy the semiconductor laser component 1. Conventionally, since the residual stress was small in the semiconductor laser component 1, the destruction of the semiconductor laser component l due to the crystal transposition did not occur. However, with increase of the residual stress accompanied with the recent high power, the semiconductor laser component 1 is destroyed due to the crystal dislocation.

On the contrary, in this embodiment, in order to decrease the residual stress of the semiconductor laser component 1, as shown in FIG. 1, before holding the semiconductor laser component 1 by the collet 4, the collet 4 is heated to a temperature more than a fusing point of the bonding member 3 with the exothermic coil 6, and heating of the heating table 5 and the collet 4 is simultaneously terminated at the time of cooling.

The collet 4 is heated to the same temperature as the heating table 5, and if the collet 4 and the heating table 5 have the same temperature profile at the time of cooling and are cooled, a difference of temperature in the semiconductor laser component 1 at the time of mounting will be small, and a temperature distribution will become almost uniform, thereby bending by difference of temperature will be prevented in the semiconductor laser component 1. Therefore, since it becomes impossible to generate the residual stress by the difference of temperature in the semiconductor laser component 1 which has been one of the causes for generation of the residual stress, the residual stress of the semiconductor laser component 1 will be decreased and degradation of laser characteristics or breakage of a semiconductor laser component can be controlled.

Moreover, the collet 4 is heated to a temperature higher than the heating table 5, and if the collet 4 is maintained to a temperature higher than a heating table 5 also at the time of cooling, a temperature distribution in the semiconductor laser component 1 at the time of mounting will be like that an area near the contacting plane of the semiconductor laser component 1 will be a low temperature, contrary to that an area near the contact surface with the collet 4 of the semiconductor laser component 1 will be a high temperature. Consequently, bending by the difference of temperature in the semiconductor laser component 1 becomes convex-like, contrary to the former. Since the bending by difference of temperature in the semiconductor laser component 1 undoes the other bending by the other two factors mutually, the semiconductor laser component 1 can be decreased, and degradation of laser characteristics or breakage of a semiconductor laser component can be controlled.

In addition, the optimum value of heating temperature for the collet 4 is determined with the quality of the material and the size of the semiconductor laser component 1, the submount 2 and the bonding member 3.

Furthermore, before making vacuum adsorption made by the collet 4, a rapid temperature change of the semiconductor laser component 1 at the time of vacuum adsorption and mounting is avoidable by heating the semiconductor laser component 1 to the same temperature as the collet 4. Degradation of laser characteristics, therefore rapid temperature change of the semiconductor laser component 1 or breakage of a semiconductor laser component can be controlled, and moreover, the mounting time can be shortened.

In addition, although the exothermic coil 6 is used for heating of the collet 4 in the above-mentioned embodiment, the collet may be heated by the other method for heating the collet 4 by other method.

### Embodiment 2: Elimination of Collet Pressure Bonding at Solidifying

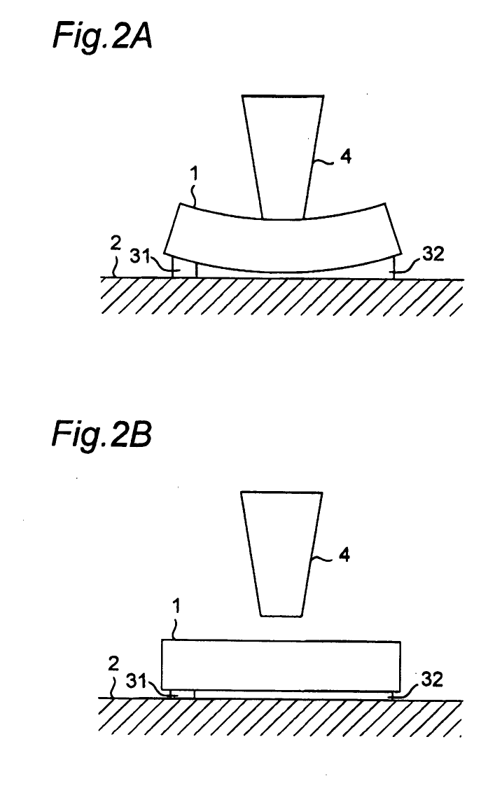

FIGS. 2A and 2B are the side views showing the embodiment 2 of this invention. The same structure of the semiconductor laser device as Embodiment 1 and the same method as a conventional mounting method are used. In this Embodiment 2, the differences from an embodiment 1 are as follows.

In the embodiment 1, before holding the semiconductor laser component 1 by the collet 4, the collet is heated to a temperature higher than a fusing point and heating of the table 5 and the collet are terminated simultaneously at the time of cooling at the time of cooling in order to decrease residual stress of the semiconductor laser component 1. In this embodiment, it is the point of making the semiconductor laser component 1 releasing from the collet 4 after a part of bonding member 3 has solidified. Therefore, an effect of a mounting method in this embodiment 2 can be explained according to FIG. 2.

Although the residual stress of the semiconductor laser component 1 is produced according to the following three factors such as a difference of temperature in the semiconductor laser component 1, a thermal expansion coefficient difference between the semiconductor laser component 1 and the submount 2, and pressure bonding by the collet 4, a part of the residual stress is generated by difference of temperature in the semiconductor laser component 1 and pressure bonding of the collet 4 when the bonding member 3 solidifies in the state where the collet 4 touches the semiconductor laser component 1. That is, if the collet 4 is released from the semiconductor laser component 1 before the bonding member 3 solidifies, generating of the residual stress caused by the two above-mentioned factors can be prevented. However, when the collet 4 is released from the semiconductor laser component 1 before the bonding member 3 solidifies, it becomes impossible to manufacture a semiconductor laser device because the semiconductor laser component 1 moves from a predetermined position, and loses a desired function.

Therefore, if the collet 4 is released from the semiconductor laser component 1 after a part of bonding member 3 has solidified, since a part of bonding member 3 has solidified, the semiconductor laser component 1 did not move from a predetermined position at the time of release of the collet 4.

Further, since most bonding member 3 has been still fused, the collet 4 will be released from the semiconductor laser component 1 in the state where the semiconductor laser component 1 has curved, by pressure bond of the collet 4, as shown in FIG. 2A and then as shown in FIG. 2B, bending of the semiconductor laser component 1 will return to the original flat state, and the bonding member 3 solidifies completely in the state where there is no bending of the semiconductor laser component 1. According to this phenomena, the residual stress due to the two above-mentioned factors can be decreased, thereby degradation of laser characteristics or breakage of a semiconductor laser component can be prevented.

There is a method using the bonding member 3 which comprises two kinds of the materials 31 and 32 which fusing points are different each other. By using the different kinds of the materials 31 and 32 which fusing point are different, the material portion 31 with a high fusing point solidifies first at the time of cooling of the semiconductor laser device, and if cooling progresses further, the material portion 32 with a low fusing point will solidify shortly. For this reason, since a time difference arises in solidification between the material portion 31 with a high fusing point and the material portion 32 with a low fusing point, after a part of bonding member 3 has solidified, the collet 4 becomes releasable from the semiconductor laser component 1.

As for the material portion 31 with a high fusing point of said bonding member 3, it is effective to use for a part of periphery section of the bonding member 3 which is not in contact with the semiconductor laser component 1 and the submount 2. The reason is explained below. Since heat is generally emitted from the external surface of a solid, a central part is higher than the periphery section of the ending member. That is, the periphery section of the bonding member 3 which is not in contact with the semiconductor laser component 1 and the submount 2 in the bonding member 3 serves as the lowest part. Therefore, if a higher fusing point material 31 is positioned on the lower temperature, the higher fusing point material solidifies first. After the higher fusing point material 3 solidify, there is a long time until the material portion 32 with a low fusing point solidifies, so that it becomes easy to carry out the steps of embodiment 2. Moreover, there is a method of making a part of bonding member 3 solidify by forced air cooling at the time of pressure bonding by the collet 4 as another method in this embodiment 2. Forced air cooling makes a temperature near the external surface side of a semiconductor laser device descend remarkably as compared with an inside, and a part of bonding member 3 can be solidified by means of forced air cooling with a cooling fan etc. at the time of cooling of a semiconductor laser device. Therefore, after a part of bonding member 3 has solidified, the collet 4 is releasable from the semiconductor laser component 1. In addition, although the bonding member 3 is constituted from two kinds of the materials which fusing point are different in the above-mentioned embodiment 2, the bonding member may be constituted from two or more kinds of quality of the materials which fusing point are different.

### Embodiment 3: Exclusion of Uneven Pressure Bonding by a Collet

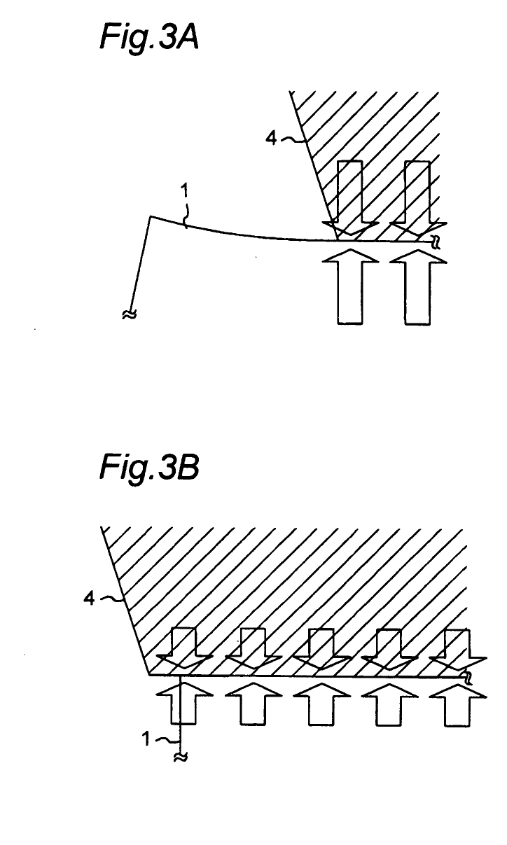

FIG. 3A and 3B are the side views showing the embodiment 3 of this invention. The same structure of the semiconductor laser device as Embodiment 1 and the same method as a conventional mounting method are used. In this Embodiment 3, the differences from an embodiment 1 are as follows.

This embodiment differs from the above-mentioned embodiments 1 and 2 in that the contacting side surface with the semiconductor laser component 1 in the collet is made to be larger than that of the contacting portion with the collet in the semiconductor, thereby the contacting area of the collet covers the contacting portion of the semiconductor laser component 1 when the collet holds the semiconductor laser component 1 by means of vacuum adsorption.

Next, an effect of a mounting method in this embodiment 3 is explained as shown in FIGS. 3A and 3B.

As one of the factors which cause the residual stress, the pressure bonding by collet 4 in the semiconductor laser component 1 is important. Since the collet 4 is generally pressure bonding a center of the semiconductor laser component 1, the semiconductor laser component 1 tends to curve in a concave. Therefore, the semiconductor laser component 1 and the submount 2 are joined after the residual stress has occurred by pressure bond of the collet 4, and also after releasing pressure bond of the collet 4, the stress by pressure bond remains in the semiconductor laser component 1.

When a field portion area in the collet which should be contacted for the semiconductor laser component 1 is small, the pressure applied to the semiconductor laser component 1 at the time of pressure bond becomes high as shown in FIG. 3A is small. Further, as the contacting portion of the collet is small, the pressure for pressing the semiconductor laser component will be weak to prevent the semiconductor laser component 1 from bending. Therefore, bending of the semiconductor laser component 1 becomes large, and the residual stress increases.

On the other hand, when area of a field portion in contact with the semiconductor laser component 1 of the collet 4 becomes large, the unit of load applied to the semiconductor laser component 1 becomes low if the same load is applied thereto. Further, as the collet has a large contacting area with the semiconductor laser component 1, the function for pressing bending of the semiconductor laser component becomes strong, thereby bending of the semiconductor laser component becomes small and the residual stree will be decreased. This tendency becomes strong when the field portion which the collet 4 contacts becomes large and becomes max when the contact surface of the semiconductor laser component 1 become equal to area of a field portion in contact with the semiconductor laser component 1 of a collet 4. For the above reason, since the residual stress of the semiconductor laser component 1 can be decreased, degradation of laser characteristics or breakage of a semiconductor laser component can be controlled.

Moreover, in this embodiment 3, as shown in FIG. 3B, when vacuum adsorption of the semiconductor laser component 1 is carried out, the reason why the contacting portion of the collet always covers the contacting portion of the semiconductor laser component 1 is based on the following reason.

Although a contact position between the collet 4 and the semiconductor laser component 1, is based also on accuracy of a mounting device, it is not always the same, and is changed with some gaps arising for every mounting, therefore even if such a gap arises, the larger contacting portion of the collet is enough to always covers the contacting portion of the semiconductor laser component 1.

### Embodiment 4: Decrease of Residual Stress by Preventing Heat Transfer to a Collet

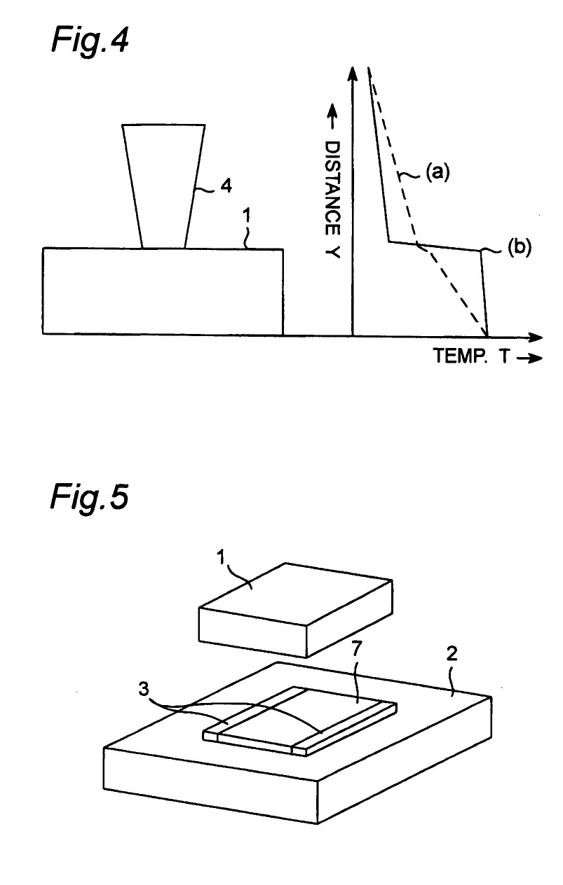

FIG. 4 is the figure showing a temperature distribution in a side view showing the embodiment 4 of this invention, and its height direction. The same structure of the semiconductor laser device as Embodiment 1 and the same method as a conventional mounting method are used. In this Embodiment 4, the differences from the embodiment 1 is a point where the quality of the material with low heat conductivity is used near the contact portion with the semiconductor laser component 1 of the collet 4.

Next, an effect of a mounting method in this embodiment is explained using FIG. 4.

A difference of temperature in the semiconductor laser component 1 is one of the factors which generate residual stresses for the semiconductor laser component 1. Heat in the semiconductor laser component 1 which is heated to a higher temperature transfers to a collet 4 having a lower temperature, thereby a difference of temperature arises in the semiconductor laser component 1 as shown in the characteristics (a) of FIG. 4A, and bending occurs.

That is, by preventing heat in the semiconductor laser component 1 from moving towards the collet 4, as shown in the characteristics (b) of FIG. 4B, temperature in the semiconductor laser component 1 can become almost uniform, and can decrease the residual stress of the semiconductor laser component 1.

Therefore, in the embodiment 1, heating of the collet 4 prevents heat in the semiconductor laser component 1 from moving to the collet 4, and temperature in the semiconductor laser component 1 is kept uniform. On the other hand, in this embodiment 4, since the collet 4 is made of the quality of the material of low heat conductivity near the contact portion with the semiconductor laser component 1, it prevents heat in the semiconductor laser component 1 from moving to the collet 4, and temperature in the semiconductor laser component 1 is kept uniform.

For the above reason, since the residual stress of the semiconductor laser component 1 can be decreased, degradation of laser characteristics or breakage of a semiconductor laser component can be prevented or controlled.

### Embodiment 5: Decrease of Residual Stress in the Luminescence Area

FIG. 5 is the perspective diagram showing the embodiment 5 of this invention.

The same structure of the semiconductor laser device as Embodiment 1 and the same method as a conventional mounting method are used. In this Embodiment, the differences from the embodiment 1 is a point where the semiconductor laser component 1 is bonded at near the macro-axis side by the bonding member 3 and intervened between either side of the bonding member by the low heat transmission materials. Next, an effect of a mounting method in this embodiment 5 is explained using FIG. 5.

Generally, in the semiconductor laser component 1 a luminescence range is arranged in the direction of a central macro axis near the contacting plane of the submount 2, in order to improve heat dissipation characteristics. Moreover, although the residual stress is produced according to the three factors such as a difference of temperature in the semiconductor laser component 1, a thermal expansion coefficient difference of the semiconductor laser component 1 and the submount 2, and the pressure bonding by the collet 4. The residual stress is produced when the bonding member 3 solidifies, so that the residual stress generates at junctions between the semiconductor laser component 1 and the submount 2. Therefore, a luminescence range of the semiconductor laser component 1 is positioned at a higher site of the residual stress in the semiconductor laser component 1.

Generally, in the semiconductor laser component 1 where a luminescence range is joined by stress of 100 or more MPas, electric current pouring causes a possibility that crystal dislocation may happen and degradation of laser characteristics or breakage of the semiconductor laser component 1 may take place. Therefore, although a method of separating a part for a junction with the submount 2 from a luminescence range is effective in order to prevent breakage of the semiconductor laser component 1 by the residual stress, if a luminescence range is separated from a junction, heat dissipation capability will decline, and it comes to cause breakage by heat shortly.

Although it is necessary to arrange a contacting plane near the luminescence range, and to take the largest possible bonding area if the bonding member 3 is intervened between the semiconductor laser component 1 and the submount 2 from a viewpoint of heat dissipation capability. On the other hand, from a view point of a bonding strength, since the bonding member may serves as a junction between the semiconductor laser component 1 and the submount 2, it is not necessary to use the bonding member 3 for all the ranges where the semiconductor laser component 1 and the submount 2 contact each other.

Therefore, as a method of reducing residual stress of a luminescence range without spoiling heat dissipation capability, as shown in FIG. 5, the bonding member 3 is used only in a part of the contacting plane, i.e. near the macro-axis side which is most distant from the luminescence range and at the other junction portion without using the bonding member 3 the heat transmission member 7 of low junction nature is intervened. Therefore, the residual stress in a luminescence range can be reduced by securing junction power of attaching the semiconductor laser component 1 to the submount 2, with the necessary minimum bonding member 3, thereby it is possible to arrange a junction used as a generating part of residual stress near the macro-axis side which is most distant from a luminescence range.

Moreover, since the heat dissipation capability is insufficient only by using the bonding member 3 near the macro-axis side of a plane of composition, the other parts other than bonding member 3 is required to make heat dissipation capability by intervening the heat transmission member 7.

Since the residual stress of a luminescence range can be reduced for the above-mentioned reason, without spoiling heat dissipation capability of the semiconductor laser component 1, degradation of laser characteristics or breakage of a semiconductor laser component can be controlled.

In addition, although the bonding member 3 is arranged the whole macro-axis side of a plane of composition in the above-mentioned embodiment, it may be arranged in a part of macro-axis side.

### Embodiment 6: Decrease of Residual Stress by Usage of Eutectic Solder

Next, the embodiment 6 of this invention is explained.

The same structure of the semiconductor laser device as Embodiment 1 and the same method as a conventional mounting method are used. In this Embodiment, the difference from the above embodiments is a point where the bonding member comprises the quality of the material with a fusing point lower than an eutectic solder.

Next, an effect of a mounting method in this embodiment 6 is explained.

Although the residual stress is produced according to the three factors such as a difference of temperature in the semiconductor laser component 1, a thermal expansion coefficient difference of the semiconductor laser component 1 and the submount 2, and the pressure bonding by the collet 4. Among the three, factors, the residual stress generated for the semiconductor laser component 1 produced according to a difference of temperature in the semiconductor laser component 1 and a difference of a thermal expansion coefficient between the semiconductor laser component 1 and the submount 2, a degree of the residual stress is influenced by the difference of temperature after the bonding member 3 solidifies until it returns to an ordinary temperature.

Below, the reason is explained.

The residual stress by difference of temperature in the semiconductor laser component 1 is produced by the following mechanisms. Although the submount 2 and the neighbor of the contacting plane of the semiconductor laser component 1 serve as a high temperature with heating at the time of mounting, since the collet 4 and the neighbor of the contact surface with the semiconductor laser component 1 serve as a low temperature because of no heating of the collet, a difference of temperature generates in the semiconductor laser component 1, at the time of mounting, and the semiconductor laser component 1 curves in a concave. If the bonding member 3 solidifies and is cooled to an ordinary temperature in this state, a power or tendency, which is going to give the semiconductor laser component return to an original flat form, functions, so that the power will turn into a residual stress which remains in the semiconductor laser component 1. Therefore, if a temperature, at which a junction solidifies, becomes low, bending of the semiconductor laser component 1 at the time of junction will become small, and a residual stress will also become low.

Moreover, the residual stress by difference of a thermal expansion coefficient between the semiconductor laser component 1 and the submount 2 is produced by the following mechanisms.

The Residual stress by difference of temperature and also by difference of a thermal expansion coefficient after the bonding member 3 solidifies completely until it returns to an ordinary temperature, occurs near the junction part. Since the thermal expansion coefficient of the semiconductor laser component 1 is generally larger than that of the submount 2, the semiconductor laser component 1 is going to curve in a concave, but the movement of the semiconductor laser component 1 is prevented, so that a residual stress generates near the joint part in the semiconductor laser component 1. Therefore, a temperature, at which the bonding member 3 solidifies, become low, so that bending of the semiconductor laser component 1 at the time of junction will become small, and the residual stress will also become low.

Generally, an eutectic solder is used for the bonding member 3 of the semiconductor laser device. Therefore, since the residual stress of the semiconductor laser component 1 can be decreased by using the quality of the material with a fusing point lower than an eutectic solder for the bonding member 3, degradation of laser characteristics or breakage of a semiconductor laser component can be controlled. This method may be used together with other mounting methods, and the residual stress can be eliminated more.

### Embodiment 7

In the above-mentioned embodiment 1-6, some residual stresses may still remain in the bonding section by a difference of temperature after a bonding member 3 solidifies completely until the bonding member 3 returns to normal temperature, and also remain in the semiconductor laser component 1 by pressure bonding of a collet. In this case, the residual stresses are completely released by re-heating the submount 2 to a temperature higher than the melting point of the bonding member 3. Although the submount 2 can be heated in accordance with heating of the heating table 5, the submount may also be heated by means of a hot wind heating, an electric heating and a high frequency heating.

1. A method of mounting a semiconductor laser device which comprises steps of heating a bonding member on a submount to be fused by heating a table where said submount is mounted, holding a semiconductor laser component by a collet and pressure bonding said semiconductor laser component in a loading position on said submount by said collet to mount said semiconductor laser component on said submount;
wherein the step of pressure bonding is carried out so as not to transfer any heat substantially from said semiconductor laser component to said collet, and the step of heating is terminated while keeping the pressure bonding for a semiconductor laser component to said submount by said collet.

2. The method of mounting a semiconductor laser device according to claim 1, wherein so as not to transfer any heat from said semiconductor laser component to said collet, said collet is heated to a substantially the same temperature as that of said table while said table is heated.

3. The method of mounting a semiconductor laser device according to claim 1, wherein said collet is maintained at a temperature higher than said heating table until said bonding member solidifies completely.

4. The method of mounting a semiconductor laser device according to claim 1, wherein said semiconductor laser component is heated to substantially the same temperature as that of said collet before said semiconductor laser component is hold by said collet.

5. The method of mounting a semiconductor laser device according to claim 1, wherein said semiconductor laser component is released from said collet when a part of said bonding member solidifies.

6. The method of mounting a semiconductor laser device according to claim 5, wherein said bonding member comprises two or more kinds of the materials having different fusing points.

7. The method of mounting a semiconductor laser device according to claim 5, wherein a part of said bonding member is solidified by means of forced air cooling during pressure bonding of said semiconductor laser component by said collet

8. The method of mounting a semiconductor laser device according to claim 1, wherein said bonding member has a fusing point lower than that of an eutectic solder.

9. The method of mounting a semiconductor laser device according to claim 1, wherein after said bonding member solidified, the bonding member is heated again higher than the fusing point.

10. The method of mounting a semiconductor laser device according to claim 1, wherein said collet has a pair of sides, which contacting side has an area larger than that of a contacting portion contacted with said semiconductor laser component.

11. The method of mounting a semiconductor laser device according to claim 1, wherein said collet has a contacting side face, a part of which contacts a semiconductor laser component and is made of a material with low heat conductivity.

12. The method of mounting a semiconductor laser device according to claim 1, wherein said semiconductor component is bonded near the macro-axis side thereof on said submount by said bonding members and the remaining parts contact on said submount through a heat transmission member.

13. A method of mounting a semiconductor laser device which comprises steps of heating a bonding member on a submount to be fused by heating a table where said submount is mounted, holding a semiconductor laser component by a collet and pressure bonding said semiconductor laser component in a loading position on said submount by said collet to mount said semiconductor laser component on said submount;
wherein said semiconductor laser component is released from said collet when a part of said bonding member solidifies.

14. The method of mounting a semiconductor laser device according to claim 13, wherein said bonding member comprises two or more kinds of the materials having different fusing points.

15. The method of mounting a semiconductor laser device according to claim 13, wherein a part of said bonding member is solidified by means of forced air cooling during pressure bonding of said semiconductor laser component by said collet

16. A method of mounting a semiconductor laser device which comprises steps of heating a bonding member on a submount to be fused by heating a table where said submount is mounted, holding a semiconductor laser component by a collet and pressure bonding said semiconductor laser component in a loading position on said submount by said collet to mount said semiconductor laser component on said submount;
wherein said collet has a contacting side face, a part of which contacts a semiconductor laser component and is made of a material with low heat conductivity.

17. A method of mounting a semiconductor laser device which comprises steps of heating a bonding member on a submount to be fused by heating a table where said submount is mounted, holding a semiconductor laser component by a collet and pressure bonding said semiconductor laser component in a loading position on said submount by said collet to mount said semiconductor laser component on said submount;
wherein said bonding member has a fusing point lower than that of an eutectic solder.
